(19) United States
(12) Patent Application Publication
(10) Pub. No.: US 2022/0405546 A1
(43) Pub. Date: Dec. 22, 2022

(54) ELECTRONIC DEVICE FOR CONVERTING ARTIFICIAL INTELLIGENCE MODEL AND OPERATING METHOD THEREOF

(71) Applicant: Samsung Electronics Co., Ltd., Suwon-si, Gyeonggi-do (KR)

(72) Inventors: Seungwook YOON, Suwon-si (KR); Jihoon O, Suwon-si (KR)

(21) Appl. No.: 17/436,418

(22) PCT Filed: Aug. 12, 2021
(86) PCT No.: PCT/KR2021/010763

§ 371 Date: Sep. 3, 2021

(30) Foreign Application Priority Data
Dec. 18, 2020 (KR) 10-2020-0178931

(51) Int. Cl. G06N 3/04

(52) U.S. Cl. CPC G06N 3/04

(57) ABSTRACT

A method performed by an electronic device is provided. The method includes obtaining an artificial intelligence model based on a first framework, determining a second framework on which an artificial intelligence model converted from the artificial intelligence model based on the first framework is to be based, obtaining a conversion graph comprising a plurality of nodes representing a plurality of frameworks, respectively, and a plurality of edges each representing that one framework is convertible into another framework, determining a path that leads from a node representing the first framework to a node representing the second framework based on the conversion graph, and converting the artificial intelligence model based on the first framework into an artificial intelligence model based on the second framework, according to the determined path.

### TECHNICAL FIELD

The disclosure relates to an electronic device for converting an artificial intelligence model and an operating method thereof.

### BACKGROUND ART

Artificial intelligence models may be trained or operate based on various framework environments. For example, an artificial intelligence model may be trained based on any one framework among various framework environments. In addition, an artificial intelligence model may operate based on any one framework among various framework environments.

In the case where an external device, on which an artificial intelligence model is to be mounted, does not support the framework that was used in training the artificial intelligence model, it is necessary to convert the artificial intelligence model such that the artificial intelligence model may operate in a framework environment that may be supported by the external device.

In the case where the framework of the artificial intelligence model, however, is unable to be converted into a desired framework due to the characteristics of the respective frameworks, the framework of the artificial intelligence model may be first converted into another framework and then converted into the desired framework. In this case, because the time required for and the accuracy of each conversion vary depending on the characteristics of respective frameworks, a method of converting an artificial intelligence model in an optimal manner is required.

The above information is presented as background information only to assist with an understanding of the disclosure. No determination has been made, and no assertion is made, as to whether any of the above might be applicable as prior art with regard to the disclosure.

### DESCRIPTION OF EMBODIMENTS

### Technical Problem

Aspects of the disclosure are to address at least the above-mentioned problems and/or disadvantages and to provide at least the advantages described below. Accordingly, an aspect of the disclosure is to provide an electronic device for converting an artificial intelligence model and an operating method thereof.

Another aspect of the disclosure is to provide a computer-readable recording medium having recorded thereon a program for executing the method on a computer. The technical objects to be solved are not limited to the above-described technical objects, and other technical objects may exist.

Additional aspects will be set forth in part in the description which follows and, in part, will be apparent from the description, or may be learned by practice of the presented embodiments.

### Technical Solution to Problem

In accordance with an aspect of the disclosure, a method for converting an artificial intelligence model performed by an electronic device is provided. The method includes obtaining an artificial intelligence model based on a first framework, determining a second framework on which an artificial intelligence model converted from the artificial intelligence model based on the first framework is to be based, obtaining a conversion graph including a plurality of nodes representing a plurality of frameworks, respectively, and a plurality of edges each representing that one framework is convertible into another framework, determining an optimal path that leads from a node representing the first framework to a node representing the second framework based on the conversion graph, and converting the artificial intelligence model based on the first framework into an artificial intelligence model based on the second framework, according to the determined optimal path.

In accordance with another aspect of the disclosure, an electronic device for converting an artificial intelligence model is provided. The electronic device includes a memory storing an artificial intelligence model based on a first framework and one or more instructions, and at least one processor configured to execute the one or more instructions stored in the memory, to determine a second framework on which an artificial intelligence model converted from the artificial intelligence model based on the first framework is to be based, obtain a conversion graph including a plurality of nodes representing a plurality of frameworks, respectively, and a plurality of edges each representing that one framework is convertible into another framework, determine an optimal path that leads from a node representing the first framework to a node representing the second framework based on the conversion graph, and convert the artificial intelligence model based on the first framework into an artificial intelligence model based on the second framework, according to the determined optimal path.

In accordance with another aspect of the disclosure, a recording medium having recorded thereon a program for executing the method is provided.

### Advantageous Effects of Disclosure

According to an embodiment of the disclosure, an artificial intelligence model may be converted to be operable on a framework different from the original framework, according to an optimal path for converting the artificial intelligence model extracted from a pre-stored conversion graph.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an example of an electronic device and an external device, according to an embodiment of the disclosure;

FIG. 2 is a diagram illustrating an example of a conversion graph, according to an embodiment of the disclosure;

FIG. 3 is a block diagram illustrating an internal configuration of an electronic device, according to an embodiment of the disclosure;

FIG. 4 is a block diagram illustrating an internal configuration of an electronic device, according to an embodiment of the disclosure;

FIG. 5 is a flowchart illustrating a method of converting an artificial intelligence model, according to an embodiment of the disclosure; and

FIG. 6 is a diagram illustrating an example of converting, by an electronic device, an artificial intelligence model, according to an embodiment of the disclosure.

Throughout the drawings, it should be noted that like reference numbers are used to depict the same or similar elements, features, and structures.

### MODE OF DISCLOSURE

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b or c” indicates only a, only b, only c, both a and b, both a and c, both b and c, all of a, b, and c, or variations thereof.

Throughout the specification, it will be understood that when an element is referred to as being “connected to” another element, it may be “directly connected to” the other element or be “electrically connected to” the other element through an intervening element. In addition, when an element is referred to as “including” a constituent element, other constituent elements may be further included not excluded unless there is any other particular mention on it.

Functions related to artificial intelligence according to the disclosure are operated by a processor and a memory. The processor may be composed of one or more processors. In this case, the one or more processors may be a general-purpose processor such as a central processing unit (CPU), an application processor (AP), or a digital signal processor (DSP), a dedicated graphics processor such as a graphics processing unit (GPU) or a vision processing unit (VPU), or a dedicated artificial intelligence (AI) processor such as a neural processing unit (NPU). The one or more processors may perform control to process input data according to predefined operation rules or an artificial intelligence model stored in the memory. Alternatively, in the case where the one or more processors are dedicated artificial intelligence processors, the dedicated artificial intelligence processor may be designed with a hardware structure specialized for processing a specific artificial intelligence model.

The predefined operation rules or artificial intelligence model may be generated via a training process. Here, being generated via a training process may mean that the predefined operation rules or artificial intelligence model set to perform desired characteristics (or purposes), is generated by training a basic artificial intelligence model by using a learning algorithm that utilizes a large number of training data. The training process may be performed by a device itself on which artificial intelligence according to the disclosure is performed, or by a separate server and/or system. Examples of the learning algorithm may include, but are not limited to, supervised learning, unsupervised learning, semi-supervised learning, or reinforcement learning.

The artificial intelligence model may be comprised of a plurality of neural network layers. Each of the plurality of neural network layers has a plurality of weight values, and performs a neural network operation through an operation between an operation result of a previous layer and the plurality of weight values. The plurality of weight values in each of the plurality of neural network layers may be optimized by a result of training the artificial intelligence model. For example, the plurality of weight values may be refined to reduce or minimize a loss or cost value obtained by the artificial intelligence model during the training process. An artificial neural network may be a deep neural network (DNN), and may be, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited thereto.

Hereinafter, the disclosure will be described in detail with reference to the accompanying drawings.

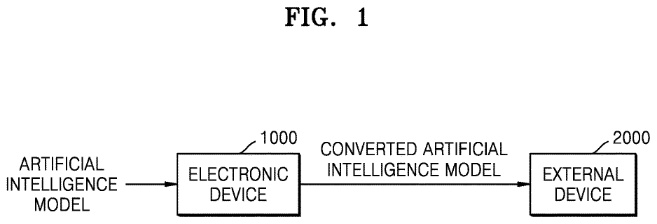

FIG. 1 is a diagram illustrating an example of an electronic device 1000 and an external device 2000, according to an embodiment of the disclosure.

Referring to FIG. 1, the electronic device 1000 according to an embodiment of the disclosure may convert an artificial intelligence model and transmit the converted artificial intelligence model to the external device 2000. The electronic device 1000 according to an embodiment of the disclosure may convert the artificial intelligence model, such that the converted artificial intelligence model may be processed by the external device 2000, based on information about frameworks that may be supported by the external device 2000.

The electronic device 1000 according to an embodiment of the disclosure may be any one of various types of devices capable of processing an artificial intelligence model. For example, the electronic device 1000 may be, but is not limited to, a digital camera, a smart phone, a laptop computer, a tablet personal computer (PC), an electronic book terminal, a digital broadcasting terminal, a personal digital assistant (PDA), a portable multimedia player (PMP), a navigation system, an MP3 player, a vehicle, etc. The electronic device 1000 may be a wearable device that may be worn by a user. The wearable device may include at least one of an accessory-type device (e.g., a watch, a ring, a cuff band, an ankle band, a necklace, spectacles, and a contact lens), a head-mounted-device (HMD), a textile or garment-integrated device (e.g. electronic garments), a body attachment device (e.g., a skin pad), or a bioimplantable device (e.g., an implantable circuit), but is not limited thereto.

The artificial intelligence model according to an embodiment of the disclosure may be trained based on any one of various frameworks. The frameworks according to an embodiment of the disclosure may include various algorithms that may be used for training an artificial intelligence model. For example, the framework may be TensorFlow, Keras, PyTorch, Caffe, Open Neural Network eXchange (ONNX), etc., but is not limited thereto, and various frameworks may be used.

According to an embodiment of the disclosure, functions, variables, and the like used in an artificial intelligence model depend on the framework on which the artificial intelligence model is based, and thus some pieces of data constituting the artificial intelligence model may be modified if the framework of the artificial intelligence model is converted into another one. Therefore, the electronic device 1000 according to an embodiment of the disclosure may convert the framework on which the artificial intelligence model is based, into a desired framework, by modifying some pieces of data constituting the artificial intelligence model, according to the desired framework.

In the case where the external device 2000 according to an embodiment of the disclosure does not support the framework used in training the artificial intelligence model, it may be difficult for the external device 2000 to process the artificial intelligence model. Therefore, the electronic device 1000 according to an embodiment of the disclosure may convert the artificial intelligence model into an artificial intelligence model based on a framework that is supported by the external device 2000, such that the artificial intelligence model may be used in the external device 2000.

The electronic device 1000 according to an embodiment of the disclosure may use a conversion tool to convert the artificial intelligence model into an artificial intelligence model based on another framework. The conversion tool according to an embodiment of the disclosure may be installed in the electronic device 1000 to convert the framework of an artificial intelligence model into another framework. According to an embodiment of the disclosure, various conversion tools may independently exist for various pairs of source and destination frameworks. For example, a conversion tool for conversion from PyTorch to ONNX, a conversion tool for conversion from ONNX to PyTorch, a conversion tool for conversion from Keras to ONNX, etc. may independently exist.

However, in the case where there is no conversion tool for direct conversion from a first framework to a second framework, the electronic device 1000 may convert the framework of an artificial intelligence model, from the first framework to the second framework by performing conversion several times by using different conversion tools. For example, a conversion tool for conversion from PyTorch to TensorFlow may not exist, whereas the conversion tool for conversion from PyTorch to ONNX and a conversion tool for conversion from ONNX to TensorFlow may be available. In this case, the electronic device 1000 may first convert the framework of an artificial intelligence model, from PyTorch to ONNX by using the conversion tool for conversion from PyTorch to ONNX, and then finally convert the framework of the artificial intelligence model, from ONNX to TensorFlow by using the conversion tool for conversion from ONNX to TensorFlow.

However, in the case where there are a plurality of various conversion tools, it may be difficult for the electronic device 1000 to select an appropriate tool for converting the framework of the artificial intelligence model, from the first framework to the second framework. According to an embodiment of the disclosure, because various combinations of conversion tools may enable conversion from one framework to another framework, a method of finding an optimal combination of conversion tools is required.

The electronic device 1000 according to an embodiment of the disclosure may find the optimal combination of conversion tools by using a prestored conversion graph. The conversion graph according to an embodiment may include a plurality of nodes representing a plurality of frameworks, respectively, and a plurality of edges each representing that one framework is convertible into another framework. For example, in the electronic device 1000, the conversion tool for conversion from PyTorch to ONNX and a conversion tool for conversion from ONNX to TenserFlow may be available. In this case, in the conversion graph, PyTorch, ONNX, and TensorFlow may be represented as nodes, respectively, and the conversion tools may be represented as a directed edge from PyTorch to ONNX and a directed edge from ONNX to PyTorch, respectively. The conversion graph is not limited to the above-described example, and may include information about frameworks and conversion tools represented in various ways.

The conversion graph according to an embodiment of the disclosure may be generated in advance based on at least one conversion tool available in the electronic device 1000. According to an embodiment of the disclosure, the conversion graph including the plurality of nodes and the plurality of edges may be generated based on the at least one conversion tool available in the electronic device 1000.

Additional information for finding the optimal combination of conversion tools for conversion of an artificial intelligence model may be allocated, as edge information, to the edges of the conversion graph according to an embodiment of the disclosure. The edge information according to an embodiment of the disclosure may include information related to an operation of converting an artificial intelligence model by the conversion tool corresponding to the edge, such as accuracy of the converted artificial intelligence model, a time taken to convert the artificial intelligence model, a failure probability, etc. in the conversion of the artificial intelligence model.

According to an embodiment of the disclosure, based on an artificial intelligence model for test, the edge information including accuracy, a required time, an amount of computation, a failure probability, etc., in conversion using the conversion tool may be generated.

The artificial intelligence model for test according to an embodiment of the disclosure is used for generating the edge information, and may be an arbitrary artificial intelligence model including the configuration of an artificial intelligence model that may be generally used. According to an embodiment of the disclosure, by applying, to the edge information, weight values determined based on the artificial intelligence model to be converted by the electronic device 1000, the edge information generated with respect to the artificial intelligence model for test may be modified to correspond to the artificial intelligence model to be converted in the electronic device 1000.

The accuracy included in the edge information according to an embodiment of the disclosure may be determined based on the accuracy of the artificial intelligence model for test converted by the conversion tool. The accuracy according to an embodiment of the disclosure may indicate a probability of outputting a correct answer with respect to input information. Accordingly, the accuracy included in the edge information may be determined based on the probability of the artificial intelligence model for test outputting a correct answer with respect to predefined input information.

The time required included in the edge information according to an embodiment of the disclosure may be determined based on a time required for the electronic device 1000 to convert the artificial intelligence model for test by using the conversion tool.

The amount of computation included in the edge information according to an embodiment of the disclosure may be determined based on an amount of computation required for the electronic device 1000 to convert the artificial intelligence model for test by using the conversion tool.

The time and the amount of computation according to an embodiment of the disclosure may vary depending on the performance of the electronic device 1000.

The failure probability included in the edge information according to an embodiment of the disclosure may be determined based on a probability that the conversion of the artificial intelligence model for test by using the conversion tool fails. According to an embodiment of the disclosure, in the case where an operator that is unable to be converted by the conversion tool, is included in operators constituting the artificial intelligence model, the conversion of the artificial intelligence model may fail. However, the disclosure is not limited the example described above, and the conversion of an artificial intelligence model by a conversion tool may fail due to various reasons. According to an embodiment of the disclosure, the failure probability included in the edge information may be determined based on the number of times the conversion of the artificial intelligence model for test has failed.

The edge information according to an embodiment of the disclosure is not limited to the example described above, and may include various pieces of information related to the conversion of the artificial intelligence model by the conversion tool. The electronic device 1000 according to an embodiment of the disclosure may determine the optimal combination of conversion tools based on the edge information.

According to an embodiment of the disclosure, in the conversion graph, at least one path through which the framework of the artificial intelligence model may be converted from the first framework to the second framework may be identified. For example, in the conversion graph, at least one path that may lead from a node representing the first framework to a node representing the second framework, through at least one edge and at least one node, may be identified.

The electronic device 1000 according to an embodiment of the disclosure may determine a cost based on the edge information regarding at least one edge included in each of the at least one path. The cost according to an embodiment of the disclosure may indicate a degree to which the conversion of the artificial intelligence model by each path is appropriate. According to an embodiment of the disclosure, the higher the cost of a path, the less appropriate the path may be determined to be. The cost according to an embodiment of the disclosure may be used to determine an optimal conversion path for the conversion of the artificial intelligence model. According to an embodiment of the disclosure, a path having the lowest cost among the at least one path may be selected as the optimal conversion path.

However, in the case where a plurality of paths have the same cost, a path including the smallest number of edges may be selected. According to an embodiment of the disclosure, whenever the artificial intelligence model is repeatedly converted, the electronic device 1000 may reconfigure an environment for the conversion of the artificial intelligence model. For example, whenever conversion corresponding to each edge is performed, the electronic device 1000 may additionally perform an operation of, for example, installing and loading a conversion tool. Accordingly, in the case where a plurality of paths have the same cost, the less the number of edges included in each path, the more appropriate the path may be determined to be.

The cost according to an embodiment of the disclosure may be determined by applying, to the edge information, weight values determined based on at least one of the performance of the electronic device 1000 or the external device 2000, or characteristics of the artificial intelligence model to be converted. For example, the weight values may be applied to values indicating a required time, an amount of computation, accuracy, a failure probability, etc. included in the edge information, and the cost of one path may be determined based on the values to which the weight values are applied. The weight values according to an embodiment of the disclosure is not limited to the example described above, and may be determined based on various pieces of information.

For example, in the case where the performance of the electronic device 1000 is relatively poor, the weight values determined such that a path having a low amount of computation may be selected from among the at least one path, may be applied to the edge information. For example, the weight value applied to the value indicating the amount of computation in the edge information may be greater than other weight values applied to other values (e.g., indicating the accuracy, the failure probability, etc.) in the edge information.

In addition, in the case where the accuracy is important due to the characteristics of the artificial intelligence model to be converted by the electronic device 1000, the weight values determined such that a path having the highest accuracy may be selected, may be applied to the edge information. For example, the weight value applied to the value indicating the accuracy (this value may be expressed to be in inverse proportion to the accuracy) in the edge information may be greater than other weight values applied to other values (e.g., indicating the amount of computation, the failure probability, etc.) in the edge information.

The electronic device 1000 according to an embodiment of the disclosure may convert the artificial intelligence model into an artificial intelligence model based on another framework that may be processed by the external device 2000, according to the path finally determined in the conversion graph.

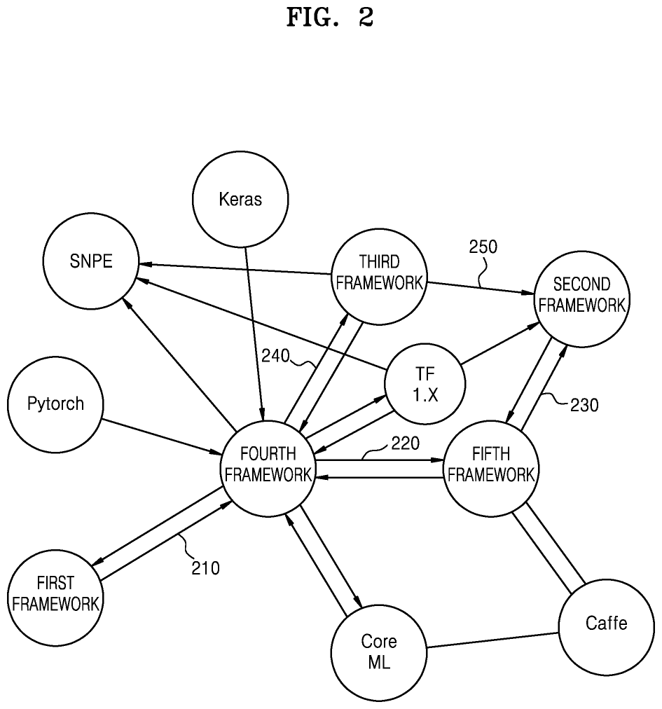

FIG. 2 is a diagram illustrating an example of a conversion graph, according to an embodiment of the disclosure.

Referring to FIG. 2, in the conversion graph according to an embodiment of the disclosure, whether conversion between various types of frameworks is possible may be represented by nodes and edges. The disclosure is not limited to the frameworks illustrated in FIG. 2, various types of frameworks may be included in the conversion graph, and the conversion graph may be continuously updated by adding a new version of each of the frameworks, a new type of framework, or a new conversion tool.

In the case where the electronic device 1000 according to an embodiment of the disclosure is to convert an artificial intelligence model based on a first framework into an artificial intelligence model based on a second framework, at least one path that leads from a node representing the first framework to a node representing the second framework may be identified in the conversion graph. For example, a first path including edges 210, 240, and 250 in sequence, and a second path including edges 210, 220, and 230 in sequence, may be identified.

A cost of the first path according to an embodiment of the disclosure may be determined based on edge information predefined for the edges 210, 240, and 250. For example, the cost for the first path may be determined based on a sum of weight values of at least one value included in the edge information regarding the edges 210, 240, and 250. Also, a cost of the second path according to an embodiment of the disclosure may be determined based on edge information predefined for the edges 210, 220, and 230. For example, the cost for the second path may be determined based on a sum of weight values of at least one value included in the edge information regarding the edges 210, 240, and 250.

Each weight value according to an embodiment of the disclosure may be determined based on at least one of the characteristics of the artificial intelligence model, the performance of the electronic device 1000, or the performance of the external device 2000, but is not limited thereto, and may be determined based on various pieces of information.

The electronic device 1000 according to an embodiment of the disclosure may convert the artificial intelligence model based on the first framework into the artificial intelligence model based on the second framework, according to a path having a lower cost among the first path and the second path. For example, in the case where the cost of the second path is lower than that of the first path, the electronic device 1000 may convert the artificial intelligence model based on the first framework into an artificial intelligence model based on a fourth framework according to the edge 210, and then convert the artificial intelligence model based on the fourth framework into an artificial intelligence model based on a fifth framework according to the edge 220. Thereafter, the electronic device 1000 may finally convert the artificial intelligence model based on the fifth framework into the artificial intelligence model based on the second framework according to the edge 230.

In the case where the conversion of the artificial intelligence model based on the fourth framework according to the edge 220 in the second path fails, the electronic device 1000 according to an embodiment of the disclosure may redetermine the optimal path not including the edge 220. As the conversion according to the edge 220 fails, the optimal path may be redetermined to lead from a node representing the fourth framework, which is the beginning point of the edge 220.

For example, the electronic device 1000 may redetermine the optimal path to be the first path including the edge 210 but not including the edge 220, and may sequentially convert, according to the edge 240 and the edge 250 in the first path, the artificial intelligence model based on the fourth framework which is already obtained by the conversion according to the edge 210 in the second path.

In addition, according to an embodiment of the disclosure, in the case where a cost of at least one path that leads from the node representing the fourth framework to the node representing the second framework is greater than or equal to a reference value, or any path that that leads from the node representing the fourth framework to the node representing the second framework does not exist, the electronic device 1000 may search for another path. For example, the electronic device 1000 may identify at least one path that leads from the first framework rather than the fourth framework, to the second framework and does not include the edge 220, and determine the optimal path according to the cost of the at least one path. The electronic device 1000 according to an embodiment of the disclosure may obtain the artificial intelligence model based on the second framework according to the redetermined optimal path, by using the artificial intelligence model based on the first framework on which the conversion according to the second path is not performed.

The disclosure is not limited to the example described above, and the electronic device 1000 may determine the optimal path not including the edge 220 in various manners.

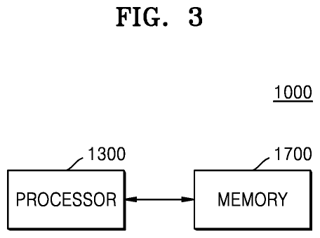

FIG. 3 is a block diagram illustrating an internal configuration of the electronic device 1000, according to an embodiment of the disclosure.

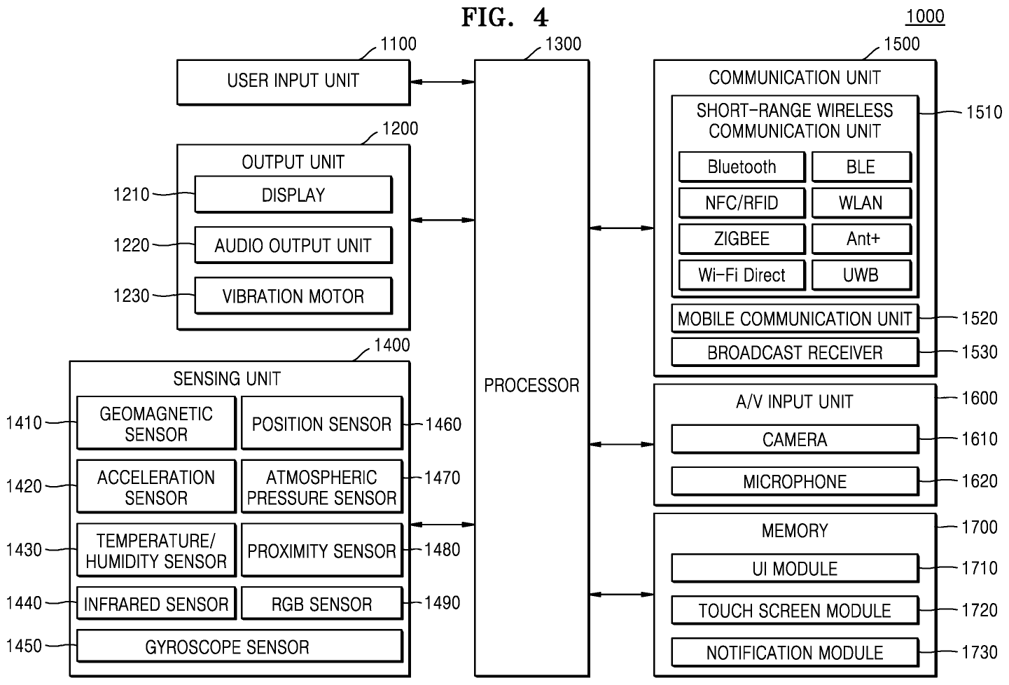

FIG. 4 is a block diagram illustrating an internal configuration of the electronic device 1000, according to an embodiment of the disclosure.

Referring to FIG. 3, the electronic device 1000 may include a processor 1300 and a memory 1700. However, all components shown in FIG. 3 are not essential components of the electronic device 1000. The electronic device 1000 may be implemented by more components than the components shown in FIG. 3, or by fewer components than the components shown in FIG. 3.

For example, as illustrated in FIG. 4, the electronic device 1000 according to an embodiment of the disclosure may further include a user input unit 1100, an output unit 1200, a sensing unit 1400, a communication unit 1500, and an audio/video (A/V) input unit 1600, in addition to the processor 1300 and the memory 1700.

The user input unit 1100 is via which a user inputs data for controlling the electronic device 1000. For example, the user input unit 1100 may be, but is not limited to, a key pad, a dome switch, a touch pad (e.g., a touch-type capacitive touch pad, a pressure-type resistive overlay touch pad, an infrared sensor-type touch pad, a surface acoustic wave conduction touch pad, an integration-type tension measurement touch pad, a piezo effect-type touch pad), a jog wheel, a jog switch, or the like.

According to an embodiment of the disclosure, the user input unit 1100 may receive a user input for converting an artificial intelligence model. For example, in response to a user input being received by the electronic device 1000, the electronic device 1000 may perform an operation of converting an artificial intelligence model to be transmitted to the external device 2000, according to an environment of the external device 2000.

The output unit 1200 may output an audio signal, a video signal, or a vibration signal, and may include a display 1210, an audio output unit 1220, and a vibration motor 1230. The output unit 1200 according to an embodiment of the disclosure may output information related to a result of converting an artificial intelligence model.

The display 1210 displays and outputs information processed by the electronic device 1000.

In the case where the display 1210 and a touch pad form a layer structure and thus constitute a touch screen, the display 1210 may also be used as an input device in addition to being used as an output device. The display 1210 may include at least one of a liquid crystal display, a thin film transistor-liquid crystal display, an organic light-emitting diode, a flexible display, a three-dimensional (3D) display, or an electrophoretic display. The electronic device 1000 may include two or more displays 1210 according to an implementation of the electronic device 1000.

The audio output unit 1220 may output audio data received from the communication unit 1500 or stored in the memory 1700.

The vibration motor 1230 may output a vibration signal. The vibration motor 1230 may also output a vibration signal in response to a touch being input to the touch screen.

The processor 1300 generally controls overall operations of the electronic device 1000. For example, the processor 1300 may generally control the user input unit 1100, the output unit 1200, the sensing unit 1400, the communication unit 1500, the A/V input unit 1600, and the like, by executing programs stored in the memory 1700.

The electronic device 1000 may include at least one processor 1300. For example, the electronic device 1000 may include various types of processors such as a central processing unit (CPU), a graphics processing unit (GPU), or a neural processing unit (NPU).

The processor 1300 may be configured to process commands of a computer program by performing basic arithmetic, logic, and input/output operations. The commands may be provided from the memory 1700 to the processor 1300, or may be received through the communication unit 1500 and provided to the processor 1300. For example, the processor 1300 may be configured to execute the commands according to program code stored in a recording device such as a memory.

The processor 1300 according to an embodiment of the disclosure may obtain an artificial intelligence model based on a first framework, and determine a second framework for conversion of the artificial intelligence model based on the first framework. In addition, the processor 1300 may obtain a conversion graph including a plurality of nodes representing a plurality of frameworks, respectively and a plurality of edges each representing that one framework is convertible into another framework, and determine, in the conversion graph, a path that leads from a node representing the first framework to a node representing the second framework. According to an embodiment of the disclosure, from among at least one path that leads from the node representing the first framework to the node representing the second framework, an optimal path may be finally determined according to a cost of each path. The processor according to an embodiment of the disclosure may convert the artificial intelligence model based on the first framework into an artificial intelligence model based on the second framework, according to the finally determined path.

The processor 1300 according to an embodiment of the disclosure may sequentially convert the artificial intelligence model according to at least one edge included in the finally determined path. However, in the case where conversion of the artificial intelligence model according to a first edge which is one of the at least one edge, fails, the processor 1300 may identify, in the conversion graph, from among paths that lead from a node which is the beginning point of the first edge, to the node representing the second framework, at least one path that does not include the first edge.

The processor 1300 according to an embodiment of the disclosure may redetermine the optimal path to be one of the identified at least one path. For example, the processor 1300 may obtain a cost of each of the identified at least one path, and may redetermine the optimal path to be a path having the lowest cost. The processor 1300 according to an embodiment of the disclosure may obtain the artificial intelligence model based on the second framework by sequentially converting the artificial intelligence model according to the redetermined optimal path.

The sensing unit 1400 may detect the state of the electronic device 1000 or the state of the periphery of the electronic device 1000, and may transmit the detected information to the processor 1300.

The sensing unit 1400 may include at least one of a geomagnetic sensor 1410, an acceleration sensor 1420, a temperature/humidity sensor 1430, an infrared sensor 1440, a gyroscope sensor 1450, a position sensor (e.g., a global positioning system (GPS)) 1460, an atmospheric pressure sensor 1470, a proximity sensor 1480, or an red green blue (RGB) sensor (illuminance sensor) 1490, but is not limited thereto.

The communication unit 1500 may include one or more components for allowing the electronic device 1000 to communicate with the external device 2000. For example, the communication unit 1500 may include a short-range wireless communication unit 1510, a mobile communication unit 1520, and a broadcast receiver 1530. The communication unit 1500 according to an embodiment of the disclosure may transmit, to the external device 2000, an artificial intelligence model converted according to an embodiment of the disclosure. In addition, the communication unit 1500 may receive, from the external device 2000, information related to the performance of the external device 2000, and the received information may be used for the electronic device 1000 to identify a framework to which the framework of the artificial intelligence model is to be converted.

The short-range wireless communication unit 1510 may include, but is not limited to, a Bluetooth communication unit, a Bluetooth Low Energy (BLE) communication unit, a near field communication (NFC) unit, a wireless local area network (WLAN) (Wi-Fi) communication unit, a Zigbee communication unit, an Infrared Data Association (IrDA) communication unit, a Wi-Fi Direct (WFD) communication unit, an ultra wideband (UWB) communication unit, an Ant+ communication unit, etc.

The mobile communication unit 1520 may transmit and receive a wireless signal to and from at least one of a base station, an external terminal, or a server, on a mobile communication network. Here, the wireless signals may include various types of data based on transmission and reception of voice call signals, video call signals, or text/multimedia messages.

The broadcast receiver 1530 may receive a broadcast signal and/or broadcast-related information from the outside through a broadcast channel. The broadcast channels may include satellite channels and terrestrial channels. According to an embodiment of the disclosure, the electronic device 1000 may not include the broadcast receiver 1530.

The A/V input unit 1600 is via which an audio signal or a video signal is input, and may include a camera 1610, a microphone 1620, and the like. The camera 1610 may operate in a video call mode or a capturing mode to obtain an image frame such as a still image or a moving image by using an image sensor. An image captured by the image sensor may be processed by the processor 1300 or a separate image processor (not shown).

The microphone 1620 may receive an external audio signal, and process the received audio signal into electrical voice data. For example, the microphone 1620 may receive a user's voice signal for performing a call.

The memory 1700 may store a program for processing and control of the processor 1300, and may store data input to the electronic device 1000 or output from the electronic device 1000.

The memory 1700 according to an embodiment of the disclosure may store a conversion graph and an artificial intelligence model. The conversion graph according to an embodiment of the disclosure may be stored in the memory 1700 in advance, and may be used to convert the artificial intelligence model according to an embodiment of the disclosure.

The memory 1700 may include at least one of flash memory, a hard disk, a multimedia card micro, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, a magnetic disc, or an optical disc.

Programs stored in the memory 1700 may be classified into a plurality of modules according to their functions, for example, into a user interface (UI) module 1710, a touch screen module 1720, a notification module 1730, etc.

The UI module 1710 may provide a specialized UI, a graphical UI (GUI), or the like which interworks with the electronic device 1000 for each application. The touch screen module 1720 may detect a touch gesture input on the touch screen by the user, and may transmit information about the touch gesture to the processor 1300. The touch screen module 1720 according to some embodiments of the disclosure may recognize and analyze touch code. The touch screen module 1720 may be configured as separate hardware including a controller.

In order to detect a touch or a proximity touch on the touch screen, various sensors may be provided inside or near the touch screen. Examples of the sensors for detecting a touch on the touch screen include a tactile sensor. The tactile sensor detects a contact of a particular object to a degree greater than or equal to the degree to which a human detects a touch. The tactile sensor may detect various pieces of information including the roughness of a contact surface, the rigidity of a contact object, or the temperature of a contact point.

A user's touch gesture may include tap, touch and hold, double-tap, drag, panning, flick, drag and drop, swipe, and the like.

The notification module 1730 may generate a signal for notifying of the occurrence of an event in the electronic device 1000.

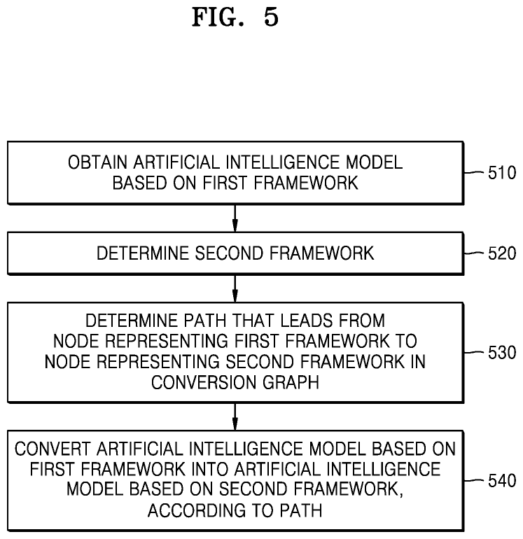

FIG. 5 is a flowchart illustrating a method of converting an artificial intelligence model, according to an embodiment of the disclosure.

Referring to FIG. 5, in operation 510, the electronic device 1000 according to an embodiment of the disclosure may obtain an artificial intelligence model based on a first framework. The artificial intelligence model according to an embodiment of the disclosure may be obtained from a memory of the electronic device 1000 or from the outside. For example, the electronic device 1000 may obtain the artificial intelligence model from another external device that trains an artificial intelligence model. The disclosure is not limited to the example described above, and the electronic device 1000 may obtain the artificial intelligence model in various manners.

In operation 520, the electronic device 1000 according to an embodiment of the disclosure may determine a second framework to which the framework of the artificial intelligence model is to be converted. The second framework according to an embodiment of the disclosure may be determined based on performance information of the external device 2000 to which the artificial intelligence model is to be transmitted. For example, the second framework may be determined as one of at least one framework that may be supported by the external device 2000. The disclosure is not limited to the example described above, and the second framework may be determined according to various criteria and methods.

In operation 530, the electronic device 1000 according to an embodiment of the disclosure may determine a path that leads from a node representing the first framework to a node representing the second framework in the conversion graph. The electronic device 1000 according to an embodiment of the disclosure may identify at least one path that leads from the node representing the first framework to the node representing the second framework by using the prestored conversion graph for artificial intelligence model conversion. According to an embodiment of the disclosure, a cost of each path may be determined based on edge information regarding edges included in each path, and a path having the lowest cost may be finally determined as an optimal path. The disclosure is not limited to the example described above, and a path suitable for the conversion of the artificial intelligence model may be determined as the optimal path in various manners.

In operation 540, the electronic device 1000 according to an embodiment of the disclosure may convert the artificial intelligence model based on the first framework into an artificial intelligence model based on the second framework, according to the optimal path determined in operation 530.

According to an embodiment of the disclosure, the artificial intelligence model may be easily converted according to the determined optimal path by using the prestored conversion graph without having to identify or individually select a plurality of conversion tools available for the electronic device 1000 to convert the artificial intelligence model.

The electronic device 1000 may sequentially convert the artificial intelligence model according to at least one edge included in the optimal path determined in operation 530. In the case where conversion of the artificial intelligence model according to a first edge which is one of the at least one edge, fails, the electronic device 1000 may identify, in the conversion graph, from among paths that lead from a node which is the beginning point of the first edge, to the node representing the second framework, at least one path that does not include the first edge.

The electronic device 1000 according to an embodiment of the disclosure may redetermine the optimal path to be one of the identified at least one path. For example, the electronic device 1000 may obtain a cost of each of the identified at least one path, and may redetermine the optimal path to be a path having the lowest cost. The electronic device 1000 according to an embodiment of the disclosure may obtain the artificial intelligence model based on the second framework by sequentially converting the artificial intelligence model according to the redetermined optimal path.

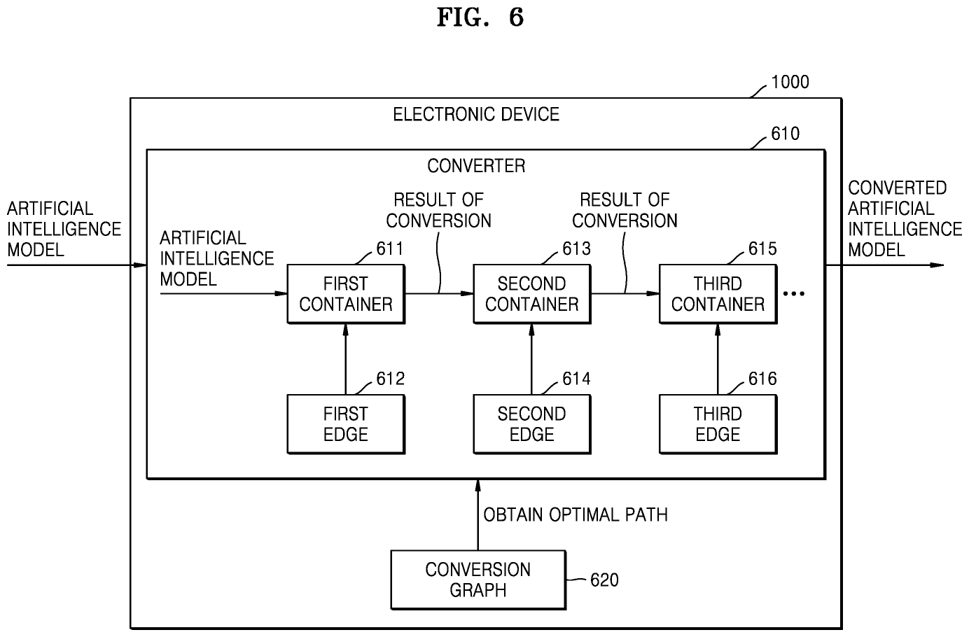

FIG. 6 is a diagram illustrating an example of converting, by the electronic device 1000, an artificial intelligence model, according to an embodiment of the disclosure.

Referring to FIG. 6, the electronic device 1000 according to an embodiment of the disclosure may include a converter 610 for sequentially converting an artificial intelligence model and a conversion graph 620.

The converter 610 according to an embodiment of the disclosure may obtain an artificial intelligence model to be converted, convert the obtained artificial intelligence model based on a first framework into an artificial intelligence model based on a second framework, and output the converted artificial intelligence model. In addition, the converter 610 according to an embodiment of the disclosure may obtain an optimal path for converting the artificial intelligence model, by using a conversion graph 620. Among at least one path that may lead from a node representing the first framework to a node representing the second framework in the conversion graph 620, a path having the lowest cost may be determined as the optimal path.

In the case where the optimal path according to an embodiment of the disclosure includes a first edge 612, a second edge 614, and a third edge 616 in sequence, the converter 610 may output the converted artificial intelligence model by sequentially converting the artificial intelligence model by using conversion tools corresponding to the edges, respectively. The disclosure is not limited to the example described above, and the optimal path according to an embodiment of the disclosure may include a smaller or larger number of edges.

The converter 610 according to an embodiment of the disclosure may convert the artificial intelligence model in a first container 611 by using a conversion tool corresponding to the first edge 612. The container according to an embodiment of the disclosure may be a virtual environment in which a conversion tool is installed and executed. According to an embodiment of the disclosure, in the case where a plurality of conversion tools are installed and executed in one device, conversion operations of some conversion tools may be inexecutable due to characteristics of each conversion tool. Therefore, by installing and executing the conversion tools in virtual environments created in containers, respectively, the artificial intelligence model may be stably converted. The disclosure is not limited to the example described above, and the artificial intelligence model according to an embodiment of the disclosure may be converted by a conversion tool in various manners. Accordingly, the first container 611 according to an embodiment of the disclosure may provide a virtual environment in which a conversion tool corresponding to the first edge 612 may be executed.

An artificial intelligence model obtained by the conversion performed in the first container 611 according to an embodiment of the disclosure may be converted in a second container 613 by a conversion tool corresponding to the second edge 614 determined according to the optimal path. In addition, an artificial intelligence model obtained by the conversion performed in the second container 613 according to an embodiment of the disclosure may be converted in a third container 615 by a conversion tool corresponding to the third edge 616 determined according to the optimal path. The second container 613 and the third container 615 according to an embodiment of the disclosure may provide virtual environments in which conversion tools corresponding to the second edge 614 and the third edge 616 may be executed, respectively.

However, for example, the conversion of the artificial intelligence model in the third container 615 may fail. For example, the conversion tool corresponding to the third edge 616 may not support conversion of some operators included in the artificial intelligence model obtained by the conversion according to the second edge 614, and thus the conversion according to the third edge 616 may fail. The disclosure is not limited to the example described above, and the conversion of the artificial intelligence model in the third container 615 may fail due to various reasons.

In this case, the converter 610 according to an embodiment of the disclosure may reobtain, by using the conversion graph 620, the optimal path that leads from the node representing the first framework to the node representing the second framework and does not include the third edge 616. According to an embodiment of the disclosure, a new container may be configured according to the reobtained optimal path, and the artificial intelligence model may be converted in at least one newly configured container.

According to an embodiment of the disclosure, the artificial intelligence model may be repeatedly converted according to the optimal path determined by using the conversion graph 620, and thus, the artificial intelligence model based on the second framework may be finally output.

According to an embodiment of the disclosure, an artificial intelligence model may be converted to be operable on a framework different from the original framework, according to an optimal path for converting the artificial intelligence model extracted from a prestored conversion graph.

A machine-readable storage medium may be provided in a form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the non-transitory storage medium may include a buffer in which data is temporarily stored.

According to an embodiment of the disclosure, the method according to various embodiments disclosed herein may be included in a computer program product and provided. The computer program product may be traded between a seller and a purchaser as a commodity. The computer program product may be distributed in a form of a machine-readable storage medium (e.g., compact disk read only memory (CD-ROM)), or may be distributed online (e.g., downloaded or uploaded) through an application store (e.g., Google Play™) or directly between two user devices (e.g., smart phones). In the case of online distribution, at least a portion of the computer program product (e.g., a downloadable app) may be temporarily stored in a machine-readable storage medium such as a manufacturer's server, an application store's server, or a memory of a relay server.

In addition, in the specification, the term “unit” may be a hardware component such as a processor or a circuit, and/or a software component executed by a hardware component such as a processor.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method for converting an artificial intelligence model performed by an electronic device, the method comprising:
obtaining an artificial intelligence model based on a first framework;
determining a second framework on which an artificial intelligence model converted from the artificial intelligence model based on the first framework is to be based;
obtaining a conversion graph comprising a plurality of nodes representing a plurality of frameworks, respectively, and a plurality of edges each representing that one framework is convertible into another framework;
determining an optimal path that leads from a node representing the first framework to a node representing the second framework based on the conversion graph; and
converting the artificial intelligence model based on the first framework into an artificial intelligence model based on the second framework, according to the determined optimal path.

2. The method of claim 1, wherein the second framework is determined based on performance information of an external device by which the artificial intelligence model is to be processed.

3. The method of claim 1, wherein the artificial intelligence model based on the first framework is converted into the artificial intelligence model based on the second framework by sequentially converting the artificial intelligence model into artificial intelligence models based on different frameworks according to an order of at least one edge included in the determined optimal path.

4. The method of claim 1, wherein the determining of the optimal path comprises:
identifying at least one path that leads from a node representing the first framework to a node representing the second framework in the conversion graph;
determining, with respect to each of the at least one path, a cost indicating a degree to which conversion of the artificial intelligence model by each path is appropriate; and
determining the optimal path based on the costs.

5. The method of claim 4, wherein the cost is determined based on edge information regarding at least one edge included in the at least one path.

6. The method of claim 5, wherein the cost is determined by applying, to the edge information, weight values determined based on at least one of characteristics of the artificial intelligence model, performance of the electronic device, or performance of an external device.

7. The method of claim 1, wherein the converting of the artificial intelligence model based on the first framework into the artificial intelligence model based on the second framework comprises:
identifying, in response to failure of conversion of the artificial intelligence model according to a first edge which is one of at least one edge included in the determined optimal path, at least one path that does not include the first edge, from among paths that lead from a node which is a beginning point of the first edge, to the node representing the second framework;
redetermining the optimal path to be one of the identified at least one path; and
obtaining the artificial intelligence model based on the second framework by sequentially converting the artificial intelligence model according to the redetermined optimal path.

8. An electronic device for converting an artificial intelligence model, the electronic device comprising:
a memory configured to store an artificial intelligence model based on a first framework and one or more instructions; and
at least one processor configured to execute the one or more instructions stored in the memory, to:
determine a second framework on which an artificial intelligence model converted from the artificial intelligence model based on the first framework is to be based,
obtain a conversion graph comprising a plurality of nodes representing a plurality of frameworks, respectively, and a plurality of edges each representing that one framework is convertible into another framework,
determine an optimal path that leads from a node representing the first framework to a node representing the second framework based on the conversion graph, and
convert the artificial intelligence model based on the first framework into an artificial intelligence model based on the second framework, according to the determined optimal path.

9. The electronic device of claim 8, wherein the second framework is determined based on performance information of an external device on which the artificial intelligence model is to be executed.

10. The electronic device of claim 8, wherein the artificial intelligence model based on the first framework is converted into the artificial intelligence model based on the second framework by sequentially converting the artificial intelligence model into artificial intelligence models based on different frameworks according to an order of at least one edge included in the determined optimal path.

11. The electronic device of claim 8, wherein the at least one processor is further configured to execute the one or more instructions stored in the memory, to:
identify at least one path that leads from a node representing the first framework to a node representing the second framework in the conversion graph;
determine, with respect to each of the at least one path, a cost indicating a degree to which conversion of the artificial intelligence model by each path is appropriate; and
determine the optimal path based on the costs.

12. The electronic device of claim 11, wherein the cost is determined based on edge information regarding at least one edge included in the at least one path.

13. The electronic device of claim 12, wherein the cost is determined by applying, to the edge information, weight values determined based on at least one of characteristics of the artificial intelligence model, performance of the electronic device, or performance of an external device.

14. The electronic device of claim 8, wherein the at least one processor is further configured to execute the one or more instructions stored in the memory, to
identify, in response to failure of conversion of the artificial intelligence model according to a first edge which is one of at least one edge included in the determined optimal path, at least one path that does not include the first edge, from among paths that lead from a node which is a beginning point of the first edge, to the node representing the second framework;
redetermine the optimal path to be one of the identified at least one path; and
obtain the artificial intelligence model based on the second framework by sequentially converting the artificial intelligence model according to the redetermined optimal path.

15. A non-transitory computer-readable recording medium having an executable program recorded thereon, wherein the program, when executed by at least one processor, instructs the at least one processor to perform the following operations:
obtaining an artificial intelligence model based on a first framework;
determining a second framework on which an artificial intelligence model converted from the artificial intelligence model based on the first framework is to be based;
obtaining a conversion graph comprising a plurality of nodes representing a plurality of frameworks, respectively, and a plurality of edges each representing that one framework is convertible into another framework;
determining an optimal path that leads from a node representing the first framework to a node representing the second framework based on the conversion graph; and
converting the artificial intelligence model based on the first framework into an artificial intelligence model based on the second framework, according to the determined optimal path.
